(19) United States
(12) Patent Application Publication
(10) Pub. No.: US 2011/0060662 A1
(43) Pub. Date: Mar. 10, 2011

(54) METHODS FOR PACKAGING PRODUCTS FOR MAILING

(76) Inventor: Michael O. Norris, Colleyville, TX (US)

(21) Appl. No.: 12/878,114

(22) Filed: Sep. 9, 2010

Related U.S. Application Data
(60) Provisional application No. 61/241,181, filed on Sep. 10, 2009.

(51) Int. Cl. G06Q 30/00; B65D 85/00; G06Q 90/00; B07C 5/342

(52) U.S. Cl. 705/27.1; 206/459.5; 705/500; 209/584

(57) ABSTRACT

Methods for packaging products for mailing A method includes receiving an order for a product by a manufacturer and from a customer, the product having an associated retail packaging that cannot be sorted using letter and flats sorting equipment. The method includes packaging the product by a manufacturer in a non-retail packaging that can be sorted using automated postal sorting equipment. The method includes, in response to the order, addressing the package to a recipient by the manufacturer using printing equipment, and delivering the packaged product to a postal system for delivery to the recipient.

### CROSS-REFERENCE TO OTHER APPLICATION

This application claims the benefit of the filing date of U.S. Provisional Patent Application 61/241,181, filed Sep. 10, 2009, which is hereby incorporated by reference.

### TECHNICAL FIELD

The present disclosure is directed, in general, to systems and methods for mail processing.

### BACKGROUND OF THE DISCLOSURE

Minimizing postal mailing and processing costs is desirable.

### SUMMARY OF THE DISCLOSURE

Various disclosed embodiments include methods for packaging products for mailing. A method includes receiving an order for a product by a manufacturer and from a customer, the product having an associated retail packaging that cannot be sorted using letter and flats sorting equipment. The method includes packaging the product by a manufacturer in a non-retail packaging that can be sorted using automated postal sorting equipment. The method includes, in response to the order, addressing the package to a recipient by the manufacturer using printing equipment, and delivering the packaged product to a postal system for delivery to the recipient.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIGS. 1A and 1B show examples of consumer retail packaging that are inefficient to ship;

FIG. 2 shows an example of the Ibuprofen packaged in non-retail packaging accordance with disclosed embodiments;

FIG. 3A illustrates another example of retail packaging and FIG. 3B shows non-retail packaging in accordance with a disclosed method; and

FIG. 4 depicts a flowchart of a method in accordance with disclosed embodiments.

Figures are not to scale.

### DETAILED DESCRIPTION

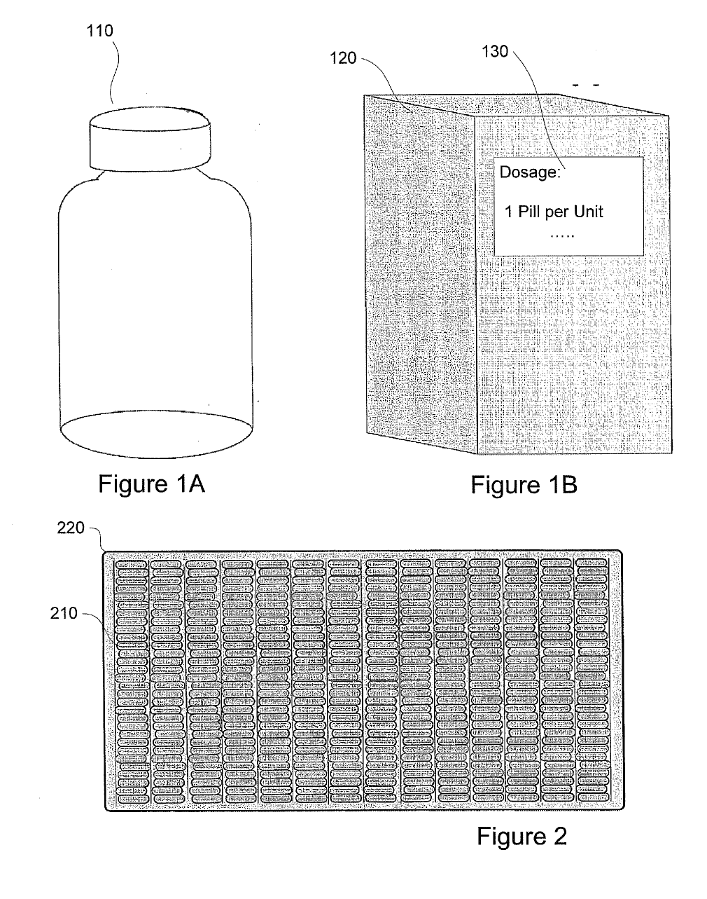

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include method for packaging physical goods so that they can be sorted on postal sorting letter and flats equipment. Therefore, the physical goods are eligible for postal rate discounts normally reserved for document-type mailings.

Flat articles can be processed by postal services and couriers using automation equipment, and the rate charged by the postal services to process and deliver flat articles depends on the quantity, size, weight, geographic entry, service level, and presort level of an entire mailing. The price for shipping a single piece far exceeds the price shippers are given for multiple piece mailings. “Presort bureau” companies have been created that consolidate mailings from multiple mailers to receive these postal discounts.

In addition, there are large volume mailers, such as banks and credit card companies that produce millions of pieces in a single mailing. These mailings can include credit card offers, bank statements, advertisements, etc. The postal services provide large volume mailers postal rate discounts which are significantly less than a single piece stamp prices. Generally, the discounts have been given for hardcopy, document-type communications which meet the physical size and shape categorized as letter and flat mail. The physical standards and rules for discounts at the United States Postal Service (USPS) are published in the USPS Domestic Mail Manual (DMM).

Packages can also be eligible for presort discounts, although the rates to mail packages are generally higher than letters and flats and have different rules. The physical standards and rules for package discounts at the USPS are also published in the USPS DMM.

Traditionally, consumer goods are packaged to be displayed in retail stores. Product manufacturers pay millions of dollars to advertisement companies to design packaging that makes their product stand out against similar products. They use bright colors, odd shapes and other gimmicks to draw attention to their product and to attract the impulse buyer. This customized packaging is often oversized for the content of the actual product or material being packaged. Therefore, the packaging could be considered inefficient for transportation, distribution and environmental purposes.

Disclosed embodiments include system and methods for packaging and shipping consumer goods in a way that they can be sorted and processed on letter and flats automation equipment. Goods processed as described can qualify for letters and flats postal rate discounts. Disclosed methods include packaging the product(s) into a form which is rectangular, fits through postal sorting equipment, and is addressed to a recipient to be delivered by the postal service.

FIG. 1 shows an example of consumer retail packaging that is inefficient to ship. FIG. 1A shows a generic retail-packaging container 110 used to contain an over-the-counter product such as ibuprofen. The container or bottle is then placed inside a cardboard retail-packaging box 120 of FIG. 1B that is appealing to the consumer and stands out from other brands of ibuprofen. In this example, the product size of each tablet is approximately ⅝″× 3/16″× 3/16″. The actual combined volume of 400 pills is about 8.8 cubic inches. If the existing container packaging to hold 400 pills were 3″×3″×3″, the packaging volume would be 27 cubic inches. Box 120 can include printed information 130 such as dosage labels, instructions, warnings, and other information.

Disclosed embodiments use an alternate way of packaging a product. FIG. 2 shows an example of the Ibuprofen packaged in non-retail packaging accordance with disclosed embodiments. In this example, the pills 210 are stacked in vertical columns of 30 pills each and sealed to form a letter sized container 220. The letter size container holds 420 pills and has the dimension 11 ¼″×6″×¼″. The volume for the alternate packaging is about 17.6 cubic inches. Using the alternate packaging there is less packaging material needed, and the new package can be processed through a typical letter sorting machine and can be delivered to the consumer as a letter.

Disclosed embodiments include a method for converting product packaging from today's containers to letter and flats sized containers that are well suited for e-commerce distribution. When a consumer orders a product off the internet, there is no need for the custom packaging to draw attention to the product. Therefore, packaging can be designed for the most efficient transportation and distribution methods.

Using the ibuprofen example above, the 400-count of pills takes the space of 8.8 cubic inches. Packaging the product in a conventional box that has three inch sides takes 27 cubic inches of space. It could be said that the packaging is about 33% efficient.

Therefore, manufacturers are shipping about 77% packaging material and air and only 33% product.

Using disclosed embodiments, the letter-sized container is 17.6 cubic inches and therefore the packaging is considered to be 50% efficient for shipping and distribution.

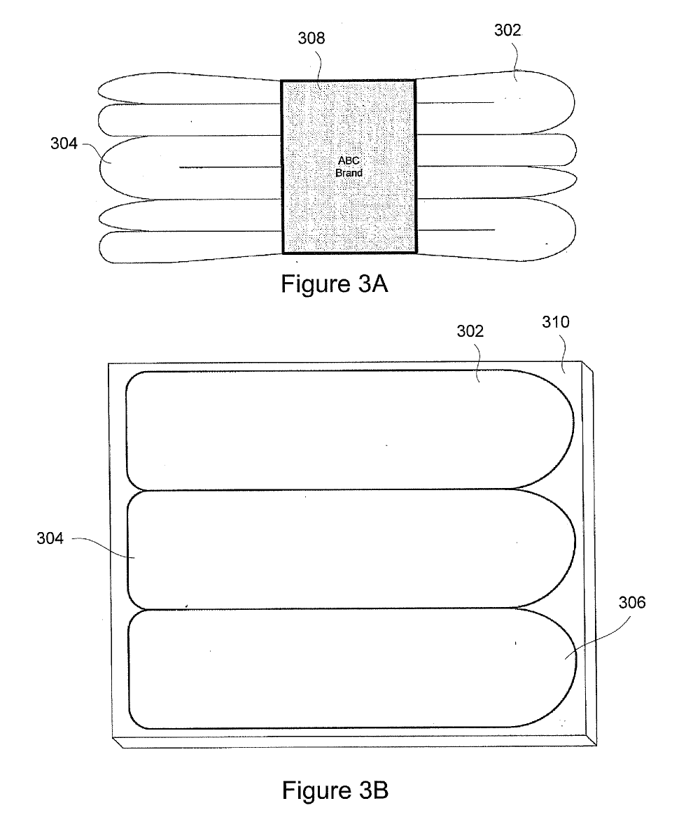

FIG. 3A illustrates another example of retail packaging. FIG. 3A shows a common technique for packaging three pairs of socks 302, 304, 306. The pairs of socks are stacked and a band 308 is placed around the set to secure the three products together. To display the product in a vertical orientation, manufacturers sometimes insert a clip device through the fold of one of the pairs. The set can be displayed by hanging the clip onto a rail in a retail store display. This kind of packaging is sufficient if the product is to be sold via a retail store, but could not be sorted using postal letters and flats sorting equipment. If this product was purchased through the Internet, the manufacturer or consumer would be required to pay the higher logistic distribution price to ship this product to the buyer because the shape of the packaging.

FIG. 3B shows a similar package of socks packaged in non-retail packaging in accordance with a disclosed method. Here, the same three pairs of socks 302, 304, 206 are intentionally packaged for distribution through postal sorting equipment and the postal delivery network. The first pair 302 is aligned on the bottom of package 310 so the longest dimension is parallel with the bottom of the packaging. The second pair 304 is placed above the first pair in the same orientation. The third pair 306 is placed above the second pair 304. The packaging is designed 310 to keep the product in place throughout the distribution process.

In various embodiments, the product can be kept in place by using a thin cardboard backing material a placing shrink wrap around the backing and the product. Another method to secure the product is to apply a tacky substance to the backing material which would hold each pair in place. The backing material and the product could be placed in a standard envelope, addressed and sent through the postal delivery network.

A typical process is inefficient and expensive in packaging and shipping. First, product is manufactured and then packaged. The packaging is normally designed to be displayed for retail sale. The retail packages are placed into a shipping container and sent to a distributor. The distributor stores product in a regional warehouse. This is referred to as case loading. A demand is created for product by consumers purchasing products from retail stores. When retail stores needs additional product, they order from the distributor.

The distributor picks product from inventory. This is referred to as broken case picking. The quantity of product ordered by the retail store is delivered to the store by the distributer or a delivery service contracted by the distributor. The product is placed into inventory or displayed at the retail store. Consumers travel to and from the store to purchase products. The cycle repeats itself as long as there is a demand for the product.

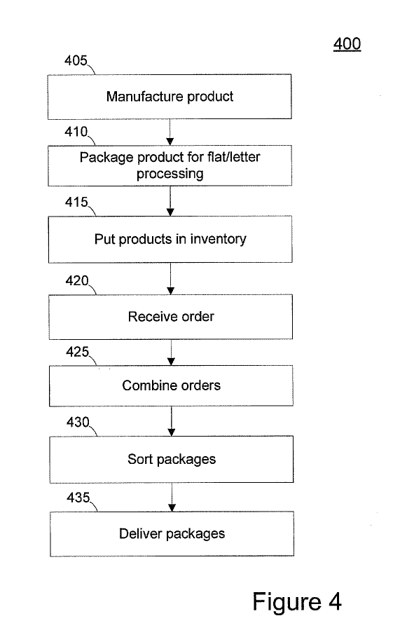

FIG. 4 depicts a flowchart of a method 400 in accordance with disclosed embodiments.

A product is manufactured (step 405). This can be any product for a consumer or business customer that is small enough so that it can be packaged and processed by automated letter and flats postal sorting equipment. The sorting equipment can be, for example, a delivery bar code sorter (DBCS), a DBCS with expanded capability (DBCS-EC), a flat sorter, or a flat sequencer, or others, with parameters defined by the USPS DMM.

The product is packaged in packaging designed to be sorted using letter and flats sorting equipment (step 410). In some embodiments, this means they products are packaged to meet the physical requirements of letters or flats described in the USPS Domestic Mail Manual, which can be referenced at time of filing at pe.usps.com/text/dmm300/101.htm. The packaging can be performed by a packing machine to transform the product from an unpackaged product to a packaged product. This step can include addressing the package to a recipient by the manufacturer using printing equipment in response to the order.

The specialized packaged products are put into inventory (step 415).

A customer order for the product is received via the phone or Internet (step 420). The customer in can be an individual consumer, another business, or otherwise.

The specific order of that product is combined with other orders of multiple products destined for the same geographical area and the consolidated products are delivered to and entered into the postal network for sorting and delivery (step 425). Combining the orders are described can also result in postal discounts.

The packaged products are sorted (step 430); letter sized products are sorted on letter sorting equipment and flats sized product are sorted on flats sorting equipment, and these can be the same equipment in some cases. The output of the letter sorting equipment is the combined letter sized hard copy communications and consumer products in a delivery sequence. The output of the flats sorting equipment is the combined flats sized hard copy communications and consumer products in a delivery sequence.

The sorted products and hard copy communications are delivered to a delivery office where postal carriers pick-up and deliver those packages as part of the mail (step 435).

In other embodiments, similar steps are performed in a different order. For example, in some embodiments, after a customer order for a product is received, that product is specially packaged as described to be processed as letters and flats. This can be the case even when the product is normally packaged in a custom retail packaging, and such specialized packaging can be performed by a manufacturer or distributor, who then delivers the product to the courier, such as the USPS, for automated sorting and eventual delivery. In some cases, the non-retail packaging requires a smaller cubic volume than the retail packaging. In some cases, the non-retail packaging requires less packaging material than the retail packaging. In some cases, the cost of shipping the product in the non-retail packaging is less than the cost of shipping the product in the retail packaging. In some cases, the ordered product includes multiple individual product units, and the multiple individual product units are packaged together in the non-retail packaging.

In some embodiments, since many products include written information such as labels, warnings, dosages, instructions, and other written information on the package itself, this information is printed on a paper sheet and included in the product package. Of course, it is possible to have retail sales of using the non-retail packaging.

In various embodiments, a sample of the retail product packaging can be scanned, printed, and the printed scanned image is included in the product package.

Those skilled in the art will recognize different variations of the method describe within and it is not the intent to describe and illustrate every alternative. For example, a manufacturer may ship their letter and flats sized product to a presort bureaus to have their products combined with letters, flats, and products from other mailers and manufacturers to receive postal discount rates.

The disclosed methods provide a technical advantage in providing a process for packaging, sorting, and delivering products more efficiently and less expensively, using less packaging and fuel. Of course, such processes are also more environmentally sound.

Various embodiments include preformed packages configured to accept the product when the package is open, and to meet the physical requirements of the USPS

DMM for flats when sealed. The package includes a label to be addressed to a customer, or a label location or holder for a label addressed to a customer. The package can include a designated location for such a label and a location for postage, and can include pre-printed indicia for discount postage. Preferably, the product in the package is not in retail packaging.

Those skilled in the art will recognize that, for simplicity and clarity, the full structure and operation of all systems suitable for use with the present disclosure is not being depicted or described herein. Instead, only so much of the physical systems and specific methods as is unique to the present disclosure or necessary for an understanding of the present disclosure is depicted and described. The remainder of the construction and operation of the systems and methods disclosed herein may conform to any of the various current implementations and practices known in the art.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, comprising:
receiving an order for a product by a manufacturer and from a customer, the product having an associated retail packaging that cannot be sorted using letter and flats sorting equipment;
packaging the product by a manufacturer in a non-retail packaging that can be sorted using automated postal sorting equipment;
in response to the order, addressing the package to a recipient by the manufacturer using printing equipment;
delivering the packaged product to a postal system for delivery to the recipient.

2. The method of claim 1, wherein the customer is a consumer.

3. The method of claim 1, wherein the customer is a business.

4. The method of claim 1, wherein the automated postal sorting equipment is a delivery bar code sorter.

5. The method of claim 1, wherein the automated postal sorting equipment is one of a flat sorter or a flat sequencer.

6. The method of claim 1, wherein non-retail packaging meets physical requirements of letters or flats described in the United States Postal Service Domestic Mail Manual.

7. The method of claim 1, further comprising combining multiple product orders.

8. The method of claim 1, further comprising sorting the packages product using the automated postal sorting equipment.

9. The method of claim 1, wherein the retail packaging includes written information, and the method further comprises packaging, with the product, a printed sheet corresponding to the written information on the retail packaging.

10. The method of claim 1, wherein the order is received over the Internet.

11. The method of claim 1, wherein the order is received by telephone.

12. The method of claim 1, wherein the ordered product includes multiple individual product units, and the multiple individual product units are packaged together in the non-retail packaging.

13. The method of claim 1, wherein the non-retail packaging requires a smaller cubic volume than the retail packaging.

14. The method of claim 1, wherein the non-retail packaging requires less packaging material than the retail packaging.

15. The method of claim 1, wherein the cost of shipping the product in the non-retail packaging is less than the cost of shipping the product in the retail packaging.

16. A packaged product, comprising:
non-retail packaging that can be sorted using automated postal sorting equipment, the non-retail packaging including an address label addressed to a recipient; and
a manufactured product packaged in the non-retail packaging, the manufactured product having associated retail packaging that has a greater cubic volume than the non-retail packaging.
